(19) United States
(12) Patent Application Publication
(10) Pub. No.: US 2026/0163136 A1
(43) Pub. Date: Jun. 11, 2026

(54) Battery Cell, Manufacturing Apparatus and Method for Battery Cell

(71) Applicant: SK On Co., Ltd., Seoul (KR)

(72) Inventor: Su Hyeon JANG, Daejeon (KR)

(21) Appl. No.: 19/405,646

(22) Filed: Dec. 2, 2025

(30) Foreign Application Priority Data
Dec. 5, 2024 (KR) 10-2024-0179807

(51) Int. Cl. H01M 50/169; B23K 26/21; H01M 50/186; H01M 50/636

(52) U.S. Cl. CPC H01M 50/169; B23K 26/21; H01M 50/186; H01M 50/636

(57) ABSTRACT

The present disclosure relates to a battery cell, a manufacturing apparatus for the battery cell, and a manufacturing method for the battery cell, and the battery cell according to one embodiment of the present disclosure may include: a case accommodating an electrode assembly; a cap plate connected to the case and including an electrolyte inlet; and a sealing cover welded to the cap plate, sealing the electrolyte inlet, and having a exposed outward facing surface, and the sealing cover may include: a bead region protruding from the exposed outward facing surface; and a scorch mark formed on the bead region.

### CROSS-REFERENCE TO RELATED APPLICATION(S)

This patent document claims the priority and benefits of Korean Patent Application No. 10-2024-0179807 filed on Dec. 5, 2024, the disclosure of which is incorporated herein by reference in its entirety.

### TECHNICAL FIELD

The disclosure and implementations disclosed in this patent document generally relate to a battery cell, as well as a manufacturing apparatus and method for the battery cell.

### BACKGROUND

A battery is widely used not only in small electronic devices such as mobile phones and laptop computers, but also in medium and large-sized mechanical devices such as electric vehicles (EVs) and energy storage devices, and may be charged and reused.

An electrode assembly including a cathode plate and an anode plate may be accommodated in a case selected according to the purpose of use thereof, such as a pouch type, a prismatic type, a cylindrical type, and the like, and an electrolyte may be injected thereto to manufacture a battery cell.

A battery module, a battery pack, an energy storage system (ESS), and the like, may be manufactured by connecting a plurality of battery cells by a busbar or the like.

A battery cell manufacturing process may include a process of removing residual electrolyte, contaminants, and the like, from the battery cell. Through this process, the quality of the battery cell may be improved.

### SUMMARY

In one aspect, the present disclosure provides a battery cell, comprising a case comprising an electrode assembly; a cap plate coupled to the case and comprising an electrolyte inlet; and a sealing cover covering the electrolyte inlet and welded to the cap plate, wherein the sealing cover comprises an exposed outward facing surface; a bead region protruding from the exposed outward facing surface; and a scorch mark formed on the bead region.

In one embodiment, the scorch mark is formed in an outside edge of the bead region. In one embodiment, the bead region has an outside edge protruding from the exposed outward facing surface by a first height, and wherein the first height is about 50 μm to about 70 μm. In one embodiment, the bead region has a width of about 0.80 mm to about 1 mm. In one embodiment, the bead region is formed along a perimeter of the sealing cover.

In another aspect, the present disclosure provides a manufacturing apparatus for a battery cell, wherein the apparatus comprises a welding unit for forming a pre-etching bead region on an exposed outward facing surface of a sealing cover disposed within an electrolyte inlet in a cap plate covering an interior cavity of a case in which at least one electrode is disposed; and a laser for etching the pre-etching bead region to form a scorch mark thereby forming a bead region.

In one embodiment, the etching unit comprises a laser for generating a laser light source; and a scanner for directing the laser light source to the sealing cover. In one embodiment, the etching unit further comprises a focusing lens for focusing the laser light source directed from the scanner onto a focus point positioned above the cap plate. In one embodiment, the focus point is positioned above the cap plate at a distance of about 1 mm to about 2 mm. In one embodiment, the apparatus further comprises a foreign matter remover that supplies gas. In one embodiment, the gas is nitrogen gas.

In another aspect, the present disclosure provides a method for manufacturing a battery cell, the method comprising covering an electrolyte inlet on a cap plate of an electrode case with a sealing cover; welding the sealing cover and a cap plate by forming a pre-etching bead region on an exposed outward facing surface of a sealing cover; and irradiating the pre-etching bead region with a laser to remove the pre-etching bead region and form a bead region and a scorch mark on the bead region.

In one embodiment, the pre-etching region has a height and wherein the irradiating comprises irradiating a laser onto the pre-etching bead region under conditions to generate a bead region having a height that is about 40% to about 60% of the height of the pre-etching bead region. In one embodiment, the laser has an average power of 300 W, a frequency of 2500 kHz or greater and 3000 kHz or less, a duration of 60 ns, an overlap of 50%, and a peak power of 1.67 kW or greater and 2.0 kW or less. In one embodiment, the irradiating comprises focusing a laser onto a focus point positioned above the cap plate at a distance of about of 1 mm to about 2 mm. In one embodiment, the irradiating comprises focusing a laser onto a focus point positioned above the cap plate at a distance of about of 1 mm to about 2 mm. In one embodiment, the irradiating comprises irradiating the laser onto an outside edge of the pre-etching bead region.

In another aspect, the present disclosure provides a method for sealing an inlet of a case, the method comprising covering the inlet of the case with a sealing cover; welding the sealing cover to the case by forming a pre-etching bead region on an exposed outward facing surface of a sealing cover; and irradiating the pre-etching bead region with a laser to remove the pre-etching bead region and form a bead region and a scorch mark on the bead region.

In one embodiment, the irradiating comprises irradiating a laser onto the pre-etching bead region under conditions to generate a bead region having a height that is about 40% to about 60% of the height of the pre-etching bead region. In one embodiment, laser has an average power of 300 W, a frequency of 2500 kHz or greater and 3000 kHz or less, a duration of 60 ns, an overlap of 50%, and a peak power of 1.67 kW or greater and 2.0 kW or less.

### BRIEF DESCRIPTION OF DRAWINGS

Certain aspects, features, and advantages of the present disclosure are illustrated by the following detailed description with reference to the accompanying drawings.

FIG. 1 is a partially exploded perspective view of a battery cell according to one embodiment of the present disclosure.

FIG. 2 is a schematic cross-sectional view of a cap plate according to the present disclosure.

FIG. 3 is a schematic plan view of a cap plate according to one embodiment of the present disclosure.

FIG. 4 schematically illustrates changes in a bead region of a battery cell during the manufacturing process of a battery cell according to one embodiment of the present disclosure.

FIG. 5 schematically illustrates a battery cell manufacturing apparatus according to one embodiment of the present disclosure.

FIG. 6 schematically illustrates the welding of a sealing cover and a cap plate by a welding unit according to one embodiment of the present disclosure.

FIG. 7 schematically illustrates the laser irradiation of a sealing cover by an etching unit according to one embodiment of the present disclosure.

FIG. 8 schematically illustrates the laser irradiation of a sealing cover by an etching unit according to another embodiment of the present disclosure.

FIG. 9 schematically illustrates a battery cell manufacturing method according to one embodiment of the present disclosure.

FIG. 10 schematically illustrates the focus point in a battery cell manufacturing method according to another embodiment of the present disclosure.

FIG. 11 schematically illustrates a battery cell manufacturing method according to another embodiment of the present disclosure.

### DETAILED DESCRIPTION

In order to help understand the description of the various embodiments of the present disclosure, elements described with the same symbol in the attached drawings are the same elements. Some components of the attached drawings are exaggerated, omitted, or schematically illustrated, and sizes of each component does not completely reflect actual sizes.

Additionally, in order to clarify the gist of the present disclosure, descriptions of elements and techniques well known by conventional techniques will be omitted, and hereinafter, the present disclosure will be described in detail with reference to the attached drawings.

Provided herein are battery cells, manufacturing apparatus, and methods of making battery cells that have exceptional characteristics. The battery cells disclosed herein may be widely applied to green technology fields, such as solar power generation and wind power generation. The battery cells and methods of their manufacture may also be applied to eco-friendly devices such as eco-friendly electric vehicles and hybrid vehicles that reduce climate change by suppressing air pollution and greenhouse gas emissions.

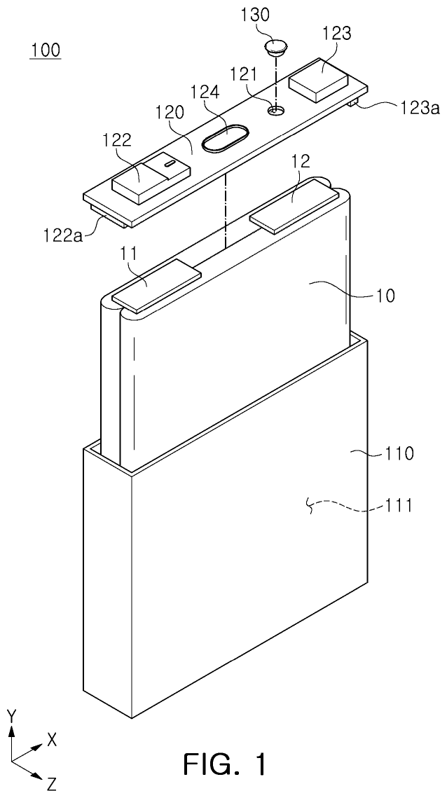

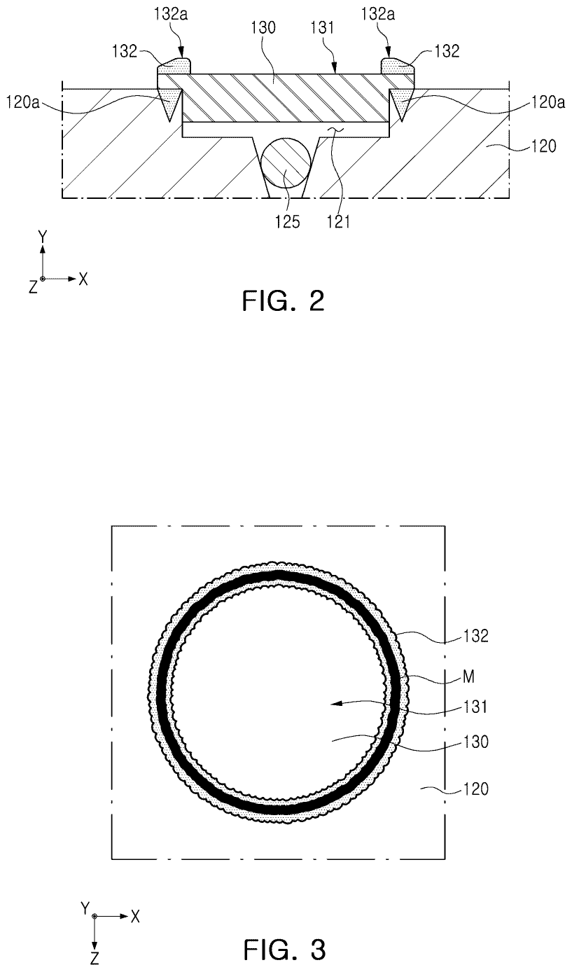

FIG. 1 is a partially exploded perspective view of a battery cell 100 according to one embodiment of the present disclosure. FIG. 2 is a cross-sectional view of a cap plate 120 according to the present disclosure.

Hereinafter, an X-axis illustrated in the drawing is a width direction of a battery cell 100 or a length direction of a cap plate 120, a Y-axis is a height direction of the battery cell 100 or a thickness direction of the cap plate 120, and a Z-axis is a thickness direction of the battery cell 100 or a width direction of the cap plate 120. However, these are directions arbitrarily set for convenience of understanding, and the above-described directions may be changed.

As illustrated in FIGS. 1 and 2, the battery cell 100 according to one embodiment of the present disclosure may comprise: a case 110 accommodating an electrode assembly 10; a cap plate 120 connected to the case 110 and comprising an electrolyte inlet 121; and a sealing cover 130 welded to the cap plate 120, sealing the electrolyte inlet 121, and comprising an exposed outward facing surface 131 exposed to the outside of the cap plate 120. In this case, the sealing cover 130 may comprise a bead region 132 protruding from the exposed outward facing surface 131 and a scorch mark M formed on the bead region 132.

The shape of each of the battery cell and case is not particularly limited. In one embodiment, the battery cell 100 may be a square battery cell 100. In such an embodiment, the case 110 may have a can shape. The material of the case is also not particularly limited, and may comprise, for example, steel. In another example, a case 110 may comprise aluminum. The case 110 may comprise an interior cavity 111. At least one electrode assembly 10 may be disposed in the interior cavity 111.

An electrode assembly 10 may comprise at least one cathode plate, at least one anode plate, and at least one separator separating the at least one cathode plate and the at least one anode plate from each other.

A cathode plate may be manufactured by methods well known in the art, for example, by coating a cathode active material on a cathode current collector. Similarly, an anode plate may be manufactured by coating an anode active material on an anode current collector.

The cathode current collector may be formed of materials commonly used in the art, for example, aluminum, stainless steel, nickel, titanium, copper, or any alloy thereof. A cathode active material may be coated on the current cathode collector in the form of a slurry in which not only the cathode active material but also one or more of a binder, a conductive agent, a dispersant, and other commonly used additive materials are mixed and stirred. Accordingly, a coating on the cathode current collector, according to certain embodiments, comprises a cathode active material and one or more of a binder, a conductive agent, and a dispersant.

The anode current collector may be formed of materials commonly used in the art, for example, copper, gold, stainless steel, nickel, aluminum, titanium, or any alloy thereof. The anode active material may be coated on the anode current collector in the form of a slurry in which not only the anode active material but also a binder, a conductive agent, a dispersant and other commonly used additive materials are mixed and stirred. Accordingly, a coating on the anode current collector, according to certain embodiments, comprises an anode active material and one or more of a binder, a conductive agent, and a dispersant.

In some embodiments, each of the cathode current collector and the anode current collector are independently formed from a material comprising a metal such as Co, Mn, or Li.

Still referring to FIGS. 1 and 2, the electrode assembly 10 may be disposed in the case 110 in any arrangement, for example, a stacked or arranged form, a stack-folding form, a Z-folding form, or a rolled form. However, the arrangement of the electrode assembly 10 is not limited by the present disclosure, and a skilled artisan will readily recognize a variety of arrangements that could be used.

An electrode 10 may comprise at least one first electrode tab 11, which may be connected to at least one cathode plate (not shown), and at least one second electrode tab 12, which may be connected to at least one anode plate (not shown). Each of the first electrode tab 11 and the second electrode tab 12 may be formed from an electrically conductive material.

A cap plate 120 may cover an interior cavity of the case 111, enclosing the electrode 10 therein, and may be reversibly coupled to the case 110. The cap plate 120 may comprise at least one vent 124, through which gas generated within the case 110, i.e., the interior cavity 111, may pass to be discharged to the outside of the case 110. Although FIGS. 1 and 2 depict one oblong vent centrally located in the cap plate 120, the location, shape, number, and construction of the at least one vent is not limited thereto and may be appropriately selected and applied based on expected operating condition and generation of gas for the battery cell 100.

The cap plate 120 may comprise a first terminal 122 and a second terminal 123, each of which may be formed from an electrically conductive material and may be disposed on the outside (i.e., surface opposite that facing the interior cavity 111 of the case 110) of the cap plate 120.

Although not shown, the first terminal 122 and the cap plate 120 may be insulated from each other by disposing an electrically insulating material therebetween. Similarly, the second terminal 123 and the cap plate 120 may also be insulated from each other by disposing an electrically insulating material therebetween. Electrically insulating material may also be disposed between the case 110 and the cap plate 120. Additional electrically insulating material may also be provided in locations other than the aforementioned locations, as needed.

The first terminal 122 may comprise a first terminal connection region 122a, which may be electrically connected to the first electrode tab 11. Similarly, the second terminal 123 may comprise a second terminal connection region 123a, which may be electrically connected to the second electrode tab 12.

The cap plate 120 may comprise a hole penetrating through the cap plate 120 for use as an electrolyte inlet 121. An electrolyte may be injected into the interior cavity 111 through the electrolyte inlet 121. When the electrolyte injection is complete, a sealing ball 125 (shown in FIG. 2) may be disposed in opening of the electrolyte inlet 121 to close electrolyte inlet 121. The sealing ball 125 may close the electrolyte inlet 121 and may prevent the electrolyte from leaking outside the case 110. For example, in certain embodiments, a portion of the sealing ball 125 may be melted to completely seal the electrolyte inlet 121.

The electrolyte inlet 121 may be covered by the sealing cover 130. The sealing cover 130 may be disposed after the electrolyte inlet 121 is sealed by the sealing ball 125.

The sealing cover 130 has an inward facing surface, which faces the interior cavity 111 of the case 110, and an exposed outward facing surface 131. The exposed outward facing surface 131 may be a surface facing the environment outside the case 110. The sealing cover 130 may be disposed to cover the electrolyte inlet 121.

The size (e.g., area) of the sealing cover is not particularly limited, provided its largest overall dimension is larger than those of the electrolyte inlet 121, such that the sealing cover cannot fully pass through the electrolyte inlet 121. For example, the area or the width of the sealing cover 130 may exceed the area or the width of the electrolyte inlet 121. In this case, the area or the width may be the area or the width in a thickness direction cross-section (X-Z plane) of the case 110.

The sealing cover 130 may be formed from any material, for example, a material comprising a metal. For example, the sealing cover 130 may comprise aluminum. In another example, the material of the sealing cover 130 may comprise or consist of AL3003.

The sealing cover 130 may be coupled to the cap plate 120, e.g., by welding. In one embodiment, a corner or an edge of the sealing cover 130 may be welded to the cap plate 120. For example, the sealing cover 130 may be coupled to the cap plate 120 by laser welding. However, the type and method of welding are not limited and a skilled artisan will readily recognize various methods that may be used to couple the sealing cover 130 to the cap plate.

As noted above, the sealing cover 130 may have an exposed outward facing surface 131. A laser may be irradiated to the exposed outward facing surface 131 to weld the sealing cover 130 and the cap plate 120. In certain embodiments, the sealing cover 130 may have a stepped cross-section (thickness direction cross-section (X-Y plane)), such as shown in FIG. 2. In such embodiment, a portion of the sealing cover 130 may be inserted into the electrolyte inlet 121.

A bead region 132 may be formed during the welding of the sealing cover 130 and cap plate 120 on at least one of the sealing cover 130 or the cap plate 120. As shown in FIG. 2, a bead region 132 is formed on the exposed outward facing surface 131 of the sealing cover 130. The bead region 132 may protrude from the exposed outward facing surface 131 of the sealing cover 130 in a height direction (Y-direction) of the battery cell 100 or in a thickness direction (Y-direction) of the cap plate 120.

A bead region 132 may comprise at least one of a back bead, a humping bead, or a portion of either thereof. For example, a humping bead may be a raised or protruding region created when molten metal accumulates excessively above a welding line during welding. If desired, at least a portion of the humping or back bead may be subsequently etched and removed, leaving behind only a portion of the humping or back bead.

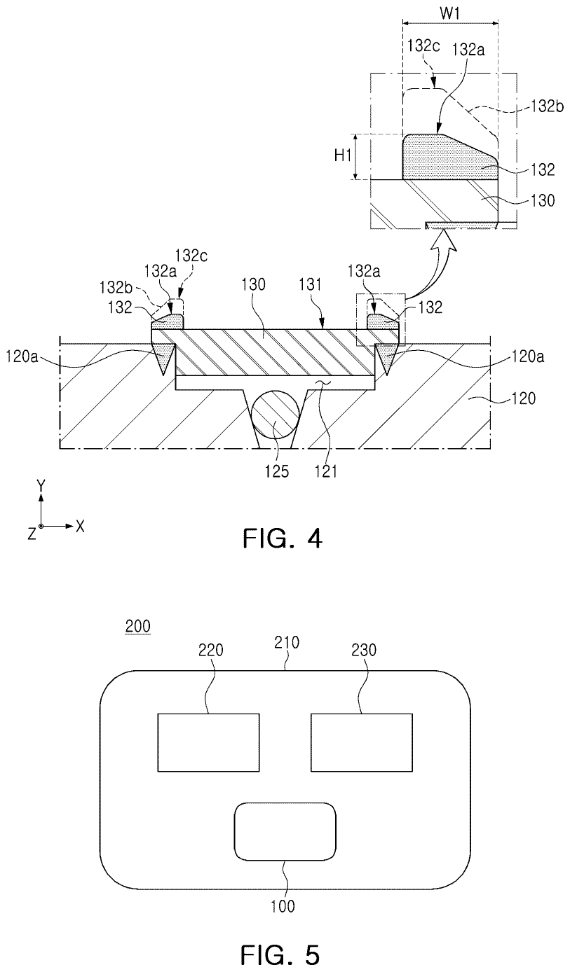

With references to FIGS. 3 and 4, at least one of the back bead and the humping bead may also exist in a pre-etching bead region 132b. The pre-etching bead region 132b may be formed after welding for bonding the sealing cover 130 and the cap plate 120 is completed.

After welding the sealing cover 130 and the cap plate 120, at least a portion of at least one of the back bead and the humping bead may be removed by laser etching. Accordingly, a bead region 132 may be formed by laser etching and removing at least a portion of the pre-etching bead region 132b. The bead region 132 may not be completely removed and may remain in at least one of the sealing cover 130 or the cap plate 120. For example, the bead region 132 may remain in the sealing cover 130.

In certain embodiments, the bead region 132 may comprise a bead pattern formed by melting a portion of the cap plate 120 and a portion of the sealing cover 130. The bead pattern may be formed by melting and then solidifying a portion of the cap plate 120 and a portion of the sealing cover 130. For example, the bead pattern may be formed at an outside edge 132a of the bead region 132. The bead pattern may have a curved or arc shape. In certain embodiments, the which the bead pattern is on an uppermost outside edge of the bead region, e.g., a portion that is furthest away from the cap plate 120 in the Y direction.

In order to visually detect the bead pattern or the bead region 132, for example, a certain amount of light may be irradiated onto the bead pattern or the bead region 132, the amount of reflected light may be detected, and results thereof may be visually displayed on an image processing device (e.g., a camera, a computer vision device, or the like). The bead pattern or the bead region 132 may also be detected with the naked eye.

As illustrated in FIG. 3, a scorch mark M may be formed in the bead region 132, for example, at an outside edge 132a of the bead region 132. The scorch mark M may be a charred or burnt trace or a mark. The scorch mark M may be formed by applying heat to the bead region 132 to burn or char the bead region 132. For example, the scorch mark M may be formed by irradiating the bead region 132 or the outside edge 132a of the bead region 132 with a laser beam.

The shape of the sealing cover 130 is not particularly limited. In one embodiment, the sealing cover 130 has a circular or cylindrical shape. Accordingly, to couple the sealing cover 130 to the cap plate 120, the welding unit may weld along a perimeter of the sealing cover 130. Accordingly, the bead region 132 may be formed along the perimeter of the sealing cover 130.

In a thickness-direction cross-section or a plane (X-Z plane) of the battery cell 100, the sealing cover 130 may be circular, and the bead region 132 may be formed along at least one boundary, edge, or perimeter of the sealing cover 130. Accordingly, the bead region 132 may also be formed in an approximately circular shape.

In the thickness-direction cross-section or the plane (X-Z plane) of the battery cell 100, a scorch mark M may be formed on the bead region 132. For example, the scorch mark M may be formed in the outside edge 132a of the bead region 132. In this case, a scorch mark M may also be formed along the perimeter of the sealing cover 130 or the bead region 132.

With reference to FIG. 4, a penetration region 120a may be formed in the cap plate 120 welded to the sealing cover 130. The penetration area 120a may be formed by melting the sealing cover 130 and the cap plate 120 with a welding heat source and refers to a region of the cap plate 120 with is deformed by the welding heat during welding.

As illustrated in FIG. 4, after welding of the sealing cover 130 and the cap plate 120 is completed, a pre-etching bead region 132b may be formed on the exposed outward facing surface 131 of the sealing cover 130. An outside edge 132c of the pre-etching bead region 132b may protrude by a certain height from the exposed outward facing surface 131 of the sealing cover 130. Scorch marks M are not formed on the outside edge 132c of the pre-etching bead region 132b.

A height of the outside edge 132c of the pre-etching bead region 132b may be higher than a height of the outside edge 132a of the bead region 132. In this case, the height may be the height of the cap plate 120 in the thickness direction (Y-direction), and the pre-etching bead region 132b may be etched to form the bead region 132.

A laser beam may be irradiated onto the pre-etching bead region 132b to etch the pre-etching bead region 132b. Accordingly, the height of the outside edge 132c of the pre-etching bead region 132b is reduced to the height of the outside edge 132a of the bead region 132.

In one embodiment, the outside edge 132a of the bead region 132 may protrude from the exposed outward facing surface 131 by a first height H1. The first height may also be a straight line distance in the Y-axis direction from the exposed outward facing surface 131 of the sealing cover 130 to the outside edge 132a of the bead region 132. In this case, the outside edge 132a of the bead region 132 may include the highest region or point of the bead region 132 in the thickness-direction cross-section (X-Y plane) of the cap plate 120. Accordingly, the first height H1 may also be expressed as a distance from the exposed outward facing surface 131 to a maximum height point of the bead region 132.

In one embodiment, the first height H1 may be a value greater than or equal to about 50 μm and less than or equal to about 70 μm. The first height H1 may be a minimum height of the bead region 132. That is, in the X-Y plane, the first height H1 may be a height from the exposed outward facing surface 131 to the lowest point or region of the bead region 132. The first height H1 may be measured using a micrometer, a laser distance meter, or the like. As used herein, the term “about” is used to refer to a value within 10% of the stated value.

Without wishing to be bound by theory, it is believed that employing a first height H1 of about 50 μm to about 70 μm reduces or prevents deformation of the sealing cover 130 or the cap plate 120 during welding. This may also allow removal of any defects that form in the pre-etching bead region 132b. Such defects that can be removed include welding defects (e.g., at least a portion of the humping bead) and contamination with foreign substances, such as an electrolyte. Removal of defective regions occurring within certain regions of the pre-etching bead region 132b may be performed without degrading the quality of the battery cell 100.

The width W1 of the bead regio 132 is not particularly limited, but in certain embodiments, may be 0.80 mm or more and 1 mm or less. The width W1 of the bead region 132 may be the width W1 of the bead region 132 in the thickness direction cross-section (X-Y) of the cap plate 120. For example, the width W1 of the bead region 132 may be a maximum width of the bead region 132. The bead region 132 may ensure a sufficient bonding region between the sealing cover 130 and the cap plate 120.

In another aspect, the present disclosure provides a battery cell manufacturing apparatus 200 for manufacturing a battery cell 100, wherein the battery cell comprises a case 110 accommodating an electrode assembly 10, a cap plate 120 connected to the case 110 and including an electrolyte inlet 121, and a sealing cover 130 welded to the cap plate 120, sealing the electrolyte inlet 121, exposing an exposed outward facing surface 131 to the outside of the cap plate 120 and including a bead region 132 protruding from the exposed outward facing surface 131.

FIG. 5 illustrates a battery cell manufacturing apparatus 200 according to one embodiment of the present disclosure. As illustrated in FIGS. 1 to 5, the battery cell manufacturing apparatus 200 according to an embodiment of the present disclosure may comprise a welding unit 220 to weld the sealing cover 130 and the cap plate 120 such that the electrolyte inlet 121 is covered by the sealing cover 130, thereby forming a pre-etching bead region 132b on the first surface 131; and an etching unit 230 to irradiate the pre-etching bead region 132b with a laser to form a scorch mark M and forming the bead region 132.

In certain embodiments, the pre-etching bead region may have a height greater than the bead region. The bead region may be a bead region protruding from the exposed outward facing surface after laser irradiation is completed. By irradiating the pre-etching bead region with a laser, at least a portion of the pre-etching bead region may be removed. Furthermore, after laser irradiation is completed on the pre-etching bead region, a region remaining protruding from the exposed outward facing surface may be a bead region. A scorch mark M may be formed on the bead region.

As depicted in FIG. 5, the welded unit 220 and the etching unit 230 may be provided on a device frame 210. Battery cells 100 may be supplied to the device frame 210. In some cases, the battery cells 100 may be supplied continuously. To this end, the device frame 210 may further include components such as a conveyor belt and a robot arm, for conveying the battery cell 100.

The battery cell 100 may be conveyed from the device frame 210 and may sequentially pass through the welding unit 220 and the etching unit 230. For example, the battery cell 100 may be supplied to the welding unit 220, and the sealing cover and the cap plate may be welded in the welding unit 220. In this case, a pre-etching bead region may be formed on the exposed outward facing surface of the sealing cover.

After the welding of the sealing cover and the cap plate is completed, the battery cell 100 may be supplied to the etching unit 230. The supply or conveying of the battery cells 100 may be performed by a conveyor belt, robot arm, or the like.

The etching unit 230 may comprise only a portion of the pre-etching bead region, the remaining portion removed by irradiating the pre-etching bead region with a laser.

In certain embodiments, a device frame 210 may further comprise a vision camera and a vision system. The vision camera, the vision system, and other related components may acquire image information of the bead region, the pre-etching bead region, the cap plate and the sealing cover, and visually display information thereof.

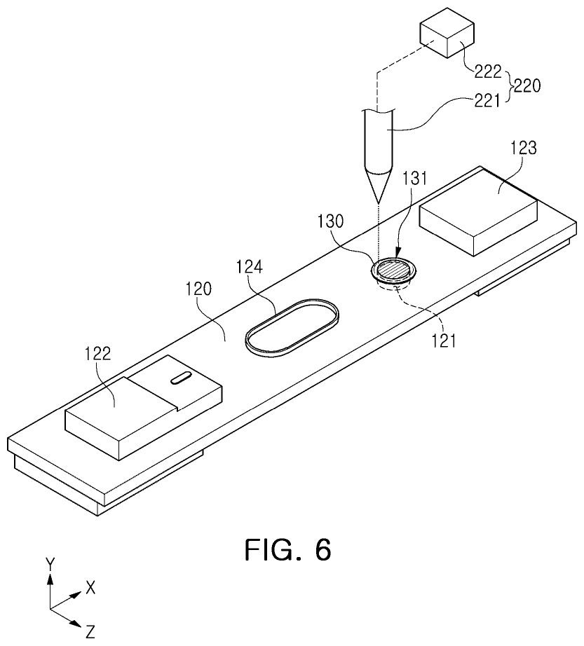

FIG. 6 illustrates the welding of the sealing cover 130 and the cap plate 120 by the welding unit 220 according to one embodiment of the present disclosure. As illustrated in FIG. 6, a welding unit 220 may comprise a welding drive member 222 connected to the welding head 221, which can be used to weld the sealing cover 130 and the cap plate 120 after the electrolyte inlet 121 is covered by the sealing cover 130. The welding head 221 may be any welding head of a laser welder. The type of welding is not necessarily limited. The welding drive member 222 may move the welding head 221. Accordingly, welding may be performed while moving along a perimeter of the sealing cover 130.

In certain embodiments, the welding drive member 222 and the welding head 221 may be connected to a controller. The controller may comprise at least one of a microcontroller or a microcontroller unit and a programmable logic controller (PLC). Accordingly, automatic welding may be performed. However, welding may also be performed manually.

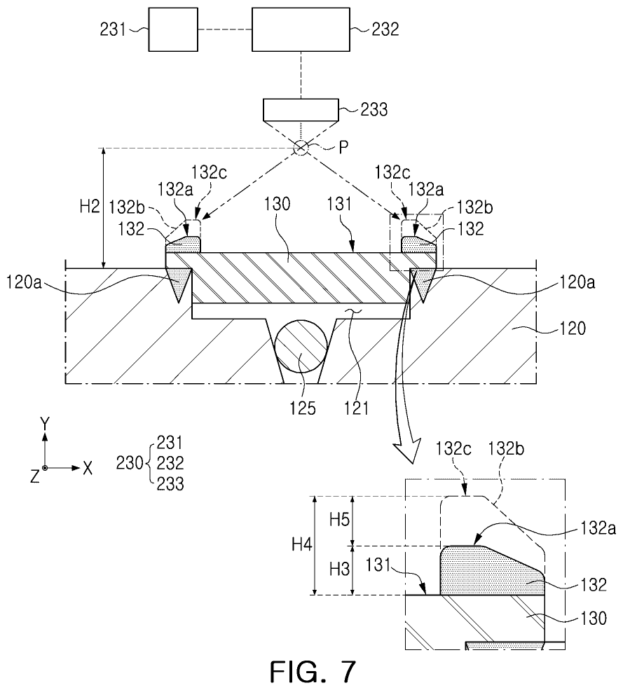

FIG. 7 illustrates the irradiation of a sealing cover 130 with a laser by an etching unit 230. As illustrated in FIG. 7, the etching unit 230 according to one embodiment of the present disclosure may comprise a laser 231, which generates a laser light source, and a scanner 232, which directs the laser light source to the sealing cover 130.

The output of the laser 231 may comprise a laser light source or a laser beam, provided the output has an average power of 300 W, a frequency of 2500 kHz or greater and 3000 kHz or less, a duration of 60 ns, an overlap of 50%, and a peak power of 1.67 kW or greater and 2.0 kW or less. By utilizing the aforementioned parameters, only defective regions can be removed, without affecting non-defective (normal) regions of the sealing cover 130 and the cap plate 120 or without deforming of the sealing cover 130 and the cap plate 120. In certain embodiments, peak power may be calculated using the following equation.

Peak Power=Average Power/(Frequency*Duration)

Here, peak power may refer to a maximum instantaneous power of the laser light source or the laser beam. The laser light source or laser beam generated by the laser 231 may have a predetermined pulse characteristic. The pulse has a width, and the peak power may be calculated from a value of a peak width (peak duration) and the repeatability (frequency) of the corresponding width (peak duration). For example, the peak power may be a ratio of pulse duration to pulse energy. The scanner 232 may supply or direct the laser light source or laser beam to the sealing cover 130. For example, the scanner 232 may supply or direct the laser light source or laser beam to the sealing cover 130 or the pre-etching bead region 132b. A scanner may include any means for directing the laser light source, for example, mirrors and/or rotating optical components.

In certain embodiment, the battery cell manufacturing apparatus 200 may further comprise a vision system to acquire image information from at least one of the sealing cover 130, the pre-etching bead region 132b, and the cap plate 120. Laser etching may be performed based on the image information acquired through the vision system.

In FIG. 7, a fourth height H4 represents the height of the pre-etching bead region 132b and may be a straight line distance from the exposed outward facing surface 131 of the sealing cover 130 to an outside edge 132c of the pre-etching bead region 132b. In this case, the height of the pre-etching bead region 132b may be a height of a point having a maximum height within the pre-etching bead region 132b.

A third height H3 represents the height of the bead region 132, which is a straight line distance from the exposed outward facing surface 131 of the sealing cover 130 to the outside edge 132a of the bead region 132. The bead region 132 is the region remaining of the pre-etching bead region 132b after the pre-etching bead region 132b is irradiated with a laser to remove a portion of the pre-etching bead region 132b. The height of the bead region 132 may be defined as maximum height within the bead region 132.

In certain embodiments, H4 is higher than H3. The etching unit 230 may reduce the height of the pre-etching bead region 132b by a fifth height H5 by irradiating the pre-etching bead region 132b with a laser. The fifth height H5 may be defined as the height of the pre-etching bead region 132b that was removed by the laser. In certain embodiments, the sum of the H3 and H5 is H4.

The etching unit 230 may reduce the height of the pre-etching bead region 132b by the fifth height H5 as measured from the outside edge 132c of the pre-etching bead region 132b. For example, the etching unit 230 may remove a portion of the pre-etching bead region 132b, wherein the portion removed is the region connecting the point having the maximum height and the point having the minimum height, wherein the minimum and maximum points are among the outside edges 132c of the pre-etching bead region 132b and in the thickness direction cross-section (X-Y plane) of the cap plate 120. The distance between the point having the maximum height and the point having the minimum height is equal to the fifth height H5. In this case, when the pre-etching bead region 132b is inclined in the X-Y plane, since there are a plurality of points or regions corresponding to the outside edges 132c of the pre-etching bead region 132b in the X-Y plane, there may be a plurality of outside edges 132c of the pre-etching bead region 132b.

In one embodiment, the third height H3 is an etching height, and may be the height of the bead region 132. The etching height may be a height of the pre-etching bead region 132b after etching is completed. The above-described first height H1 may have the same value as the height of the bead region 132 and the third height H3.

In one embodiment, the fifth height H5 may have a value that is greater than or equal to 40% and less than or equal to about 60% of the fourth height H4. That is, the fifth height H5 may have any one value within a range of about 40% or more and about 60% or less of the fourth height H4. In this case, when the bead region 132 and/or the pre-etching bead region 132b are formed to be inclined or oblique, the fifth height H5 may have a plurality of values.

In one embodiment, the fifth height H5 may have the same value as the height or length of a straight line parallel to the Y-axis in the thickness-direction cross-section (X-Y plane) of the cap plate 120 and connecting the outside edge 132c of the pre-etched bead region 132b and the outside edge 132a of the bead region 132.

When the bead region 132 and/or the pre-etched bead region 132b are inclined or at an angle oblique to the cap plate 120, the fifth height H5 may be calculated by moving the outside edge 132c of the pre-etched bead region 132b and the outside edge 132a of the bead region 132 in a width direction (X-direction) of the bead region 132. In this case, the fifth height H5 may have a plurality of values.

For example, a straight line connecting the outside edge 132c of the pre-etching bead region 132b having the lowest height and the outside edge 132a of the bead region 132 that overlaps the outside edge 132c of the pre-etching bead region 132b having the lowest height in the Y-axis direction may be a fifth height H5, and a straight line connecting the outside edge 132c of the pre-etching bead region 132b having the highest height and the outside edge 132a of the bead region 132 that overlaps the outside edge 132c of the pre-etching bead region 132b having the highest height in the Y-axis direction may also be a fifth height H5. Based on this principle, the straight line may be formed by moving in the width direction (X-direction) of the bead region 132. Accordingly, the fifth height H5 may have a plurality of values.

Here, a plurality of fifth heights H5 may have the same value or different values. However, the values of the plurality of fifth heights H5 may be within a range of about 40% or more and about 60% or less of the fourth height H4.

In one embodiment, the fourth height H4 may be about 120 μm, the fifth height H5 may be about 60 μm, and the third height H3 may be about 60 μm. In such embodiments, a weld defect region (such as a humping bead) formed on at least one of the sealing cover 130 and the cap plate 120 the sealing cover 130 may be easily removed.

In one embodiment, a vision system, sensor, and the like, may be utilized to monitor the removal of a pre-etching bead region 132b, the height of the bead region 132 during the process, or any other parameters related thereto.

In addition, in one embodiment, the etching unit 230 may further include a focusing lens 233 to focus a laser light source directed from the scanner 232 onto a focus point P on the cap plate 120. The position of the focus point P may be adjusted, e.g., by changing the characteristics (e.g., thickness, concavity, etc.) and/or position of the focusing lens 233.

In one embodiment, the focus point P is positioned above the cap plate 120 (in a thickness-wise cross-section (X-Y plane) of the cap plate 120) at a distance of about 1 mm or more and about 2 mm or less. The focus point P may be spaced apart from the cap plate 120 by a second height H2. The second height H2 may have the same value as a separation distance between the focus point P and the cap plate 120. In this case, the separation distance or the second height H2 may have any one value within the range of 1 mm or more and 2 mm or less.

The quality of the bead region 132, for example, formation of a scorch mark M in the outside edge 132a of the bead region 132 in which laser etching is performed, may be inspected using a vision system, or the like.

In one embodiment, the etching unit 230 and the welding unit 220 may be connected to a controller. The controller may comprise at least one of a microcontroller, a microcontroller unit, or a programmable logic controller (PLC). Accordingly, automatic etching may be performed. However, the etching operation may also be performed manually.

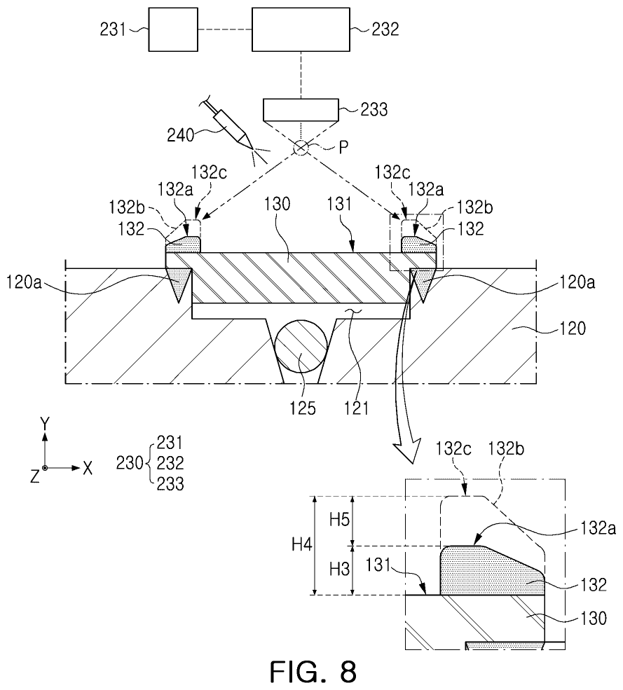

FIG. 8 illustrates another example of irradiation of a sealing cover 130 with a laser by an etching unit 230. As illustrated in FIG. 8, a battery cell manufacturing apparatus 200 may further comprise a foreign matter remover 240 that supplies gas to the sealing cover 130 to remove foreign matter (or scrap, chips, or the like) generated during laser etching may be moved to the outside of the battery cell 100 with the gas. For example, the foreign matter remover 240 may supply nitrogen gas to the sealing cover 130. By using nitrogen gas, oxidation of the welding area or bead region 132 of the sealing cover 130 may be minimized. A skilled person will readily recognize other gasses that also will avoid oxidation of the welding area or bead region. A separate discharge box may be provided to collect foreign matter removed by the gas. However, this is not necessarily limited by the present disclosure.

In another aspect, the present disclosure provides a method of manufacturing a battery cell 100, wherein the battery cell comprises a case 110 accommodating an electrode assembly 10, a cap plate 120 connected to the case 110 and including an electrolyte inlet 121, and a sealing cover 130 welded to the cap plate 120, sealing the electrolyte inlet 121, having a exposed outward facing surface 131 exposed to the outside of the cap plate 120, and including a bead region 132 protruding from the exposed outward facing surface 131.

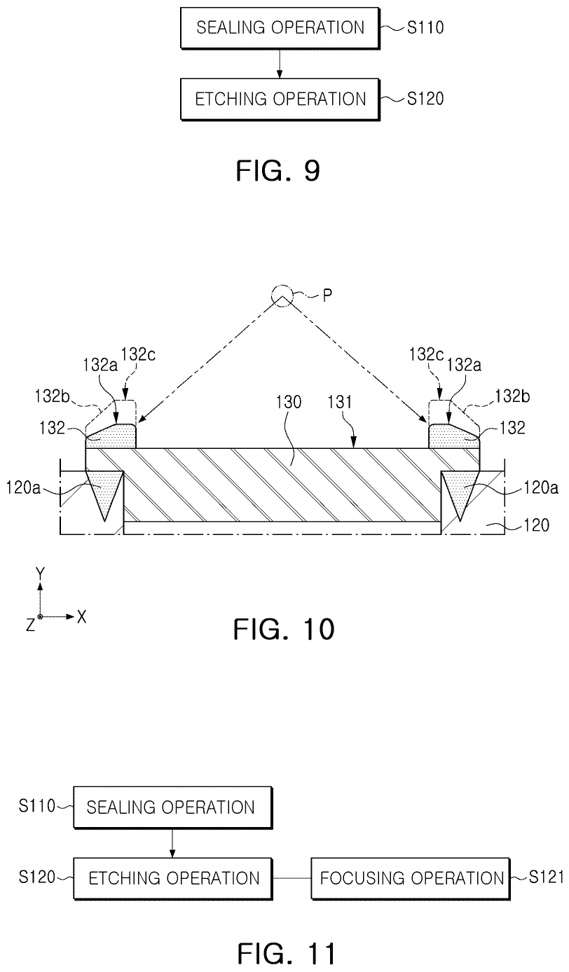

FIG. 9 illustrates a manufacturing method for a battery cell 100 according to one embodiment of the present disclosure. A method for manufacturing a battery cell 100 may comprise welding the sealing cover 130 and the cap plate 120 as part of a sealing operation (S110). For example, the electrolyte inlet 121 may be covered by the sealing cover 130 and a pre-etching bead region 132b may be formed on the exposed outward facing surface 131. Thereafter, the pre-etching bead region 132b may be irradiated with a laser to form the bead region 132 to form a scorch mark M on the bead region 132 as part of an etching operation (S120) performed after the sealing operation (S110).

In another example of a sealing operation (S110), the sealing cover 130 and the cap plate 120 may be laser welded. For example, the sealing operation (S110) may be performed using the above-described battery cell manufacturing apparatus 200.

In the sealing operation (S110), the sealing cover 130 may be secured to the cap plate 120, and the electrolyte inlet 121 may be sealed by the sealing cover 130.

After the sealing operation (S110) is completed, a bead region 132 may be formed on at least one region of the sealing cover 130 and the cap plate 120. For example, a bead region 132 may be formed on the sealing cover 130 after a sealing operation (S110).

A bead region 132 may comprise at least one of a back bead, a humping bead, or a portion of either thereof. For example, a humping bead may be a raised or protruding region created when molten metal accumulates excessively above a welding line during welding. Humping beads may form during high-speed welding or when excessive current is used and may degrade weld quality. Accordingly, at least a portion of the humping or back bead may be subsequently etched and removed via an etching operation (S120), leaving behind only a portion of the humping or back bead to improve weld quality. An etching operation (S120) may be performed, for example, using the battery cell manufacturing apparatus 200 described above.

For example, an etching operation (S120) may be performed after the sealing operation (S110) is completed. The etching operation (S120) may be performed after the sealing cover 130 is secured to the cap plate 120 and seals the electrolyte inlet 121.

After the etching operation (S120) is completed and the pre-etching bead region 132b is removed, the bead region 132 remains on which a scorch mark M may be formed.

In one embodiment of an etching operation (S120), the pre-etching bead region 132b is irradiated with a laser such that the height of the bead region 132, or “etching height” is a third height H3. The etching height/third height H3 may be a value greater than or equal to about 40% and less than or equal to about 60% of a height of the pre-etching bead region 132b. The height of the pre-etching bead region 132b may be a fourth height H4.

In one embodiment of an etching operation (S120), the pre-etching bead region 132b may be irradiated by a laser light source or laser beam having an average power of 300 W, a frequency of 2500 kHz or higher and 3000 kHz or lower, a duration of 60 ns, an overlap of 50%, and a peak power of 1.67 kW or higher and 2.0 kW or lower.

FIG. 10 illustrates one embodiment of a method for manufacturing a battery cell 100 depicting focus point P in a manufacturing method for a battery cell. FIG. 11 provides a method for manufacturing method for a battery cell according to one embodiment of the present disclosure.

As illustrated in FIGS. 10 and 11, an etching operation (S120) may comprise a focusing operation (S121) wherein a laser is focused onto a focus point P positioned above the cap plate 120, for example, at a distance of about 1 mm or more and about 2 mm or less.

The focusing operation (S121) may be performed using a focusing lens 233 and may further comprise moving the focusing lens 233. The position of the focus point P may be adjusted, e.g., by changing the characteristics (e.g., thickness, concavity, etc.) and/or position of the focusing lens 233.

After the focusing operation (S121), the pre-etching bead region 132b may be etched such that the resulting height of the bead region 132 is 40% or more and 60% or less of the height of the pre-etching bead region 132b. For example, in certain embodiments, the height of the bead region is 50% of the height of the pre-etched bead region 132b. This allows for easy removal of only the weld defect region, while preventing damage and reduction in quality to the sealing cover 130 and the cap plate 120.

In another embodiment of an etching operation (S120), the laser may be irradiated onto or focused on the outside edge 132c of the pre-etched bead region 132b. Accordingly, a scorch mark M may be formed in the outside edge 132a of the etched bead region 132. The scorch mark M may be a mark or a trace formed on the bead region 132 by laser etching.

The above-described contents are merely an example of applying the principles of the present disclosure, and other components may be included or substituted without departing from the scope of the present disclosure. In addition, the present disclosure may be implemented by deleting or changing some of the components in the above-described embodiments, and each embodiment may be implemented in combination with each other.

What is claimed is:

1. A battery cell, comprising:
a case comprising an electrode assembly;
a cap plate coupled to the case and comprising an electrolyte inlet; and
a sealing cover covering the electrolyte inlet and welded to the cap plate, wherein the sealing cover comprises:
an exposed outward facing surface;
a bead region protruding from the exposed outward facing surface; and
a scorch mark formed on the bead region.

2. The battery cell of claim 1, wherein the scorch mark is formed in an outside edge of the bead region.

3. The battery cell of claim 1, wherein the bead region has an outside edge protruding from the exposed outward facing surface by a first height, and wherein the first height is about 50 μm to about 70 μm.

4. The battery cell of claim 1, wherein the bead region has a width of about 0.80 mm to about 1 mm.

5. The battery cell of claim 1, wherein the bead region is formed along a perimeter of the sealing cover.

6. A manufacturing apparatus for a battery cell, wherein the apparatus comprises:
a welding unit for forming a pre-etching bead region on an exposed outward facing surface of a sealing cover disposed within an electrolyte inlet in a cap plate covering an interior cavity of a case in which at least one electrode is disposed; and
a laser for etching the pre-etching bead region to form a scorch mark thereby forming a bead region.

7. The manufacturing apparatus for a battery cell of claim 6, wherein the etching unit comprises:
a laser for generating a laser light source; and
a scanner for directing the laser light source to the sealing cover.

8. The manufacturing apparatus for a battery cell of claim 7, wherein the etching unit further comprises a focusing lens for focusing the laser light source directed from the scanner onto a focus point positioned above the cap plate.

9. The manufacturing apparatus for a battery cell of claim 8, wherein the focus point is positioned above the cap plate at a distance of about 1 mm to about 2 mm.

10. The manufacturing apparatus for a battery cell of claim 6, further comprising a foreign matter remover that supplies gas.

11. The manufacturing apparatus for a battery cell of claim 10, wherein the gas is nitrogen gas.

12. A method for manufacturing a battery cell, the method comprising:
covering an electrolyte inlet on a cap plate of an electrode case with a sealing cover;
welding the sealing cover and a cap plate by forming a pre-etching bead region on an exposed outward facing surface of a sealing cover; and
irradiating the pre-etching bead region with a laser to remove the pre-etching bead region and form a bead region and a scorch mark on the bead region.

13. The manufacturing method for a battery cell of claim 12, wherein the pre-etching region has a height and wherein the irradiating comprises irradiating a laser onto the pre-etching bead region under conditions to generate a bead region having a height that is about 40% to about 60% of the height of the pre-etching bead region.

14. The manufacturing method of claim 12, wherein the laser has an average power of 300 W, a frequency of 2500 kHz or greater and 3000 kHz or less, a duration of 60 ns, an overlap of 50%, and a peak power of 1.67 kW or greater and 2.0 kW or less.

15. The manufacturing method for a battery cell of claim 12, wherein the irradiating comprises focusing a laser onto a focus point positioned above the cap plate at a distance of about of 1 mm to about 2 mm.

16. The manufacturing method for a battery cell of claim 13, wherein the irradiating comprises focusing a laser onto a focus point positioned above the cap plate at a distance of about of 1 mm to about 2 mm.

17. The manufacturing method for a battery cell of claim 12, wherein the irradiating comprises irradiating the laser onto an outside edge of the pre-etching bead region.

18. A method for sealing an inlet of a case, the method comprising:
covering the inlet of the case with a sealing cover;
welding the sealing cover to the case by forming a pre-etching bead region on an exposed outward facing surface of a sealing cover; and
irradiating the pre-etching bead region with a laser to remove the pre-etching bead region and form a bead region and a scorch mark on the bead region.

19. The method of claim 18, wherein the irradiating comprises irradiating a laser onto the pre-etching bead region under conditions to generate a bead region having a height that is about 40% to about 60% of the height of the pre-etching bead region.

20. The manufacturing method of claim 19, wherein the laser has an average power of 300 W, a frequency of 2500 kHz or greater and 3000 kHz or less, a duration of 60 ns, an overlap of 50%, and a peak power of 1.67 kW or greater and 2.0 kW or less.
